(19) United States
(12) Patent Application Publication
(10) Pub. No.: US 2011/0141269 A1
(43) Pub. Date: Jun. 16, 2011

(54) Systems And Methods For Monitoring On-Line Webs Using Line Scan Cameras

(76) Inventors: Stephen Michael Varga, Loveland, OH (US); Charles Jeffrey Spaulding, Township, OH (US)

(21) Appl. No.: 12/639,266

(22) Filed: Dec. 16, 2009

(51) Int. Cl. H04N 7/18

(52) U.S. Cl. 348/92; 348/E07.085

(57) ABSTRACT

Various embodiments are directed to apparatuses for inspecting an on-line product web moving relative to the apparatus in a machine direction. The apparatuses may comprise a line-scan camera defining a field of view and positioned such that the field of view includes a portion of the product web. A camera control system may be in electronic communication with the camera and may be configured to receive from the web velocity sensor web velocity data indicating a velocity of the product web and convert the web velocity data to a line trigger signal. The line trigger signal may indicate a temporal frequency of camera image captures necessary to achieve a constant machine direction pixel resolution. Additionally, the camera control system may be configured to receive product position data and generate a frame trigger signal considering the product position data. The frame trigger signal may indicate a break between image frames.

### FIELD OF THE DISCLOSURE

Various embodiments are directed to systems and methods for manufacturing disposable absorbent articles, and more particularly, methods and apparatuses for monitoring on-line webs using line scan cameras.

### BACKGROUND

Along a production line, diapers and various types of other absorbent articles may be assembled by adding components to and otherwise modifying one or more advancing, continuous webs of material in a series of pitched unit operations. Some pitched unit operations may act on a single advancing web. For example, various printing and/or cutting operations may be performed on a single web. Other pitched unit operations may operate on multiple advancing webs. For example, in some processes, multiple advancing webs of material are combined into one. In some processes, one or more pitched unit operations may be used to convert an advancing web into a series of discrete components, which may then be combined with a second advancing web to form a product or component thereof. Webs of material and component parts used to manufacture diapers may include, for example, backsheets, topsheets, absorbent cores, front and/or back ears, fastener components, and various types of elastic webs and components such as leg elastics, barrier leg cuff elastics, and waist elastics. Once the desired component parts are assembled, the advancing web(s) and component parts are subjected to a final knife cut to separate the web(s) into discrete diapers or other absorbent articles. The discrete diapers or absorbent articles may also then be folded and packaged.

Various types of sensors and/or imaging equipment may be used to monitor advancing webs of material. The size of existing two-dimensional imaging equipment, however, can limit its usefulness in on-line environments, such as diaper assembly lines. This is because the complex and often bulky on-line equipment for manufacturing diapers and other web-based products limits the areas where two-dimensional imaging equipment may be installed.

### SUMMARY

Various embodiments are directed to apparatuses for inspecting an on-line product web moving relative to the apparatus in a machine direction. The apparatuses may comprise a line-scan camera defining a field of view and positioned such that the field of view includes a portion of the product web. The apparatuses may also comprise an illumination source positioned to illuminate the product web and a web velocity sensor positioned to sense a velocity of the product web in the machine direction. A camera control system may be in electronic communication with the camera and may comprise at least one computer hardware component configured to receive from the web velocity sensor web velocity data indicating a velocity of the product web and convert the web velocity data to a line trigger signal. The line trigger signal may indicate a temporal frequency of camera image captures necessary to achieve a constant machine direction pixel resolution. Additionally, the camera control system may be configured to receive product position data indicating a position of at least one product on the web relative to the field of view of the camera and generate a frame trigger signal considering the product position data. The frame trigger signal may indicate a break between image frames captured by the camera. Each image may correspond to at least one object on the web selected from the group consisting of a product and a component of a product.

### BRIEF DESCRIPTION OF THE DRAWINGS

The above-mentioned and other features and advantages of the present disclosure, and the manner of attaining them, will become more apparent and the present disclosure itself will be better understood by reference to the following description of various non-limiting embodiments of the present disclosure taken in conjunction with the accompanying drawings, wherein:

FIG. 1 illustrates one embodiment of a line scan camera system positioned in conjunction with a moving web.

FIG. 2A illustrates one embodiment of a three-dimensional view of a support apparatus for supporting the line scan camera system 100 of FIG. 1.

FIG. 2B illustrates a side view of the support apparatus of FIG. 2A.

FIG. 2C illustrates a front view of the support apparatus of FIG. 2A.

FIG. 3 illustrates one embodiment of a product of the moving web of FIG. 1 illustrating a series of image positions.

FIG. 4 illustrates one embodiment of an image frame showing a portion of the moving web of FIG. 1 comprising a product and portions of adjacent products.

FIG. 5 illustrates one embodiment of an inspection system 500 that comprises a plurality of the line scan camera systems of FIG. 1.

### DESCRIPTION

As used herein, the following terms are defined as follows.

“Absorbent article” is used herein to refer to consumer products whose primary function is to absorb and retain soils and wastes. “Diaper” is used herein to refer to an absorbent article generally worn by infants and incontinent persons about the lower torso. The term “disposable” is used herein to describe absorbent articles which generally are not intended to be laundered or otherwise restored or reused as an absorbent article (e.g., they are intended to be discarded after a single use and may also be configured to be recycled, composted or otherwise disposed of in an environmentally compatible manner).

“Pitched unit operation” refers herein to a MD fabrication apparatus having a pitch related function for working one or more webs in the manufacture of disposable absorbent articles, a portion, or a component of a disposable absorbent article. For example, the unit operation can include, but is not limited to such pitched web working apparatuses as a severing or cutting device, an embossing device, a printing device, a web activator, a discrete patch placing device (e.g., a cut-and-slip unit), a web combining device, and the like, all of which have in common that they include a machine cycle corresponding to a product pitch length (e.g., a circumference or a trajectory movement of a rotary cutting device, a combining device and the like).

Various embodiments are directed to systems and methods for monitoring moving on-line webs using line scan cameras. One or more line scan cameras may be oriented such that their field of view includes a portion of the product web. Image frames showing products comprising the web and/or components of the products may be generated by using the line scan camera to capture a series of narrow line images as the web moves across the field of view. The line images are then combined to form the image frame. Using this method, the pixel resolution of the image frames in the cross direction is fixed based on the size of the camera's one dimensional array and the nature of the lenses used. In the machine direction, however, the pixel resolution depends on the amount of moving web that passes through the field of view while each line image is captured.

According to various embodiments, a line trigger signal may be generated based on the velocity of the moving web. The line trigger signal may be provided to the line scan camera as an indication of when line images should be captured. The frequency of the line trigger signal may correspond to a temporal frequency of line images necessary to achieve a constant machine direction pixel resolution. For example, the constant machine direction pixel resolution may be selected to correspond to the cross-directional pixel resolution in order to achieve an image frame with square pixels. For example, a square pixel may correspond to equal dimensions of the moving web in both the cross direction and the machine direction. In addition to the line trigger signal, frame trigger signals may also be generated. A frame trigger signal may indicate to the line scan camera when to end one image frame and begin another. The frame trigger signal may be determined to generate image frames showing a denomination of the moving web showing one complete product, a predetermined number of products and/or one or more product components. Accordingly, the frame trigger signal may be generated considering a position of a product or product relative to the field of view of the camera.

In some embodiments, multiple line scan cameras having different functionalities and capabilities may be joined together to form a camera network. For example, different types of line scan cameras may have different levels of on-board processing capacity. Smart line scan cameras may form images into image frames and may additionally include on-board processing functionality for applying one or more image processing algorithms. For example, smart line scan cameras may include one or more digital signal processors (DSP's). Simple line scan cameras, on the other hand, may not include on board processing functionality. For example, some simple line scan cameras may receive as input a line trigger signal and provide as output individual images. A frame-grabber board or other hardware and/or software component may combine successive images into image frames. Other simple line scan cameras may receive as input both a line trigger signal and a frame trigger signal. Based on these signals, the camera may generate and provide as output image frame comprising the juxtaposition of multiple line images. Different cameras of different capabilities may be combined on the network utilizing a common communication protocol including, for example, TCP/IP, FTP, the IEEE1394 (FIREWIRE) protocol, the GIGE VISION protocol and/or the Ethernet Industrial Protocol (E/IP) developed by ROCKWELL AUTOMATION. It will be appreciated that, in some embodiments, the network may comprise area scan cameras in addition to the line scan cameras.

Also, in some embodiments, a line scan camera or network of cameras (e.g., line scan and/or area scan) may be utilized to implement multi-tier image processing. A first tier of image processing algorithms may be applied to all or a large portion of the total image frames captured. The first tier algorithms may check for basic product and/or component properties or defects. If additional processing is required or desired for a given image frame, a second tier of more computationally expensive algorithms may be applied. According to various embodiments, first-tier algorithms may be applied either at the line scan camera itself or at a local image processing computer. Second tier algorithms may be applied at a central location having the processing capacity to apply the second tier algorithms efficiently.

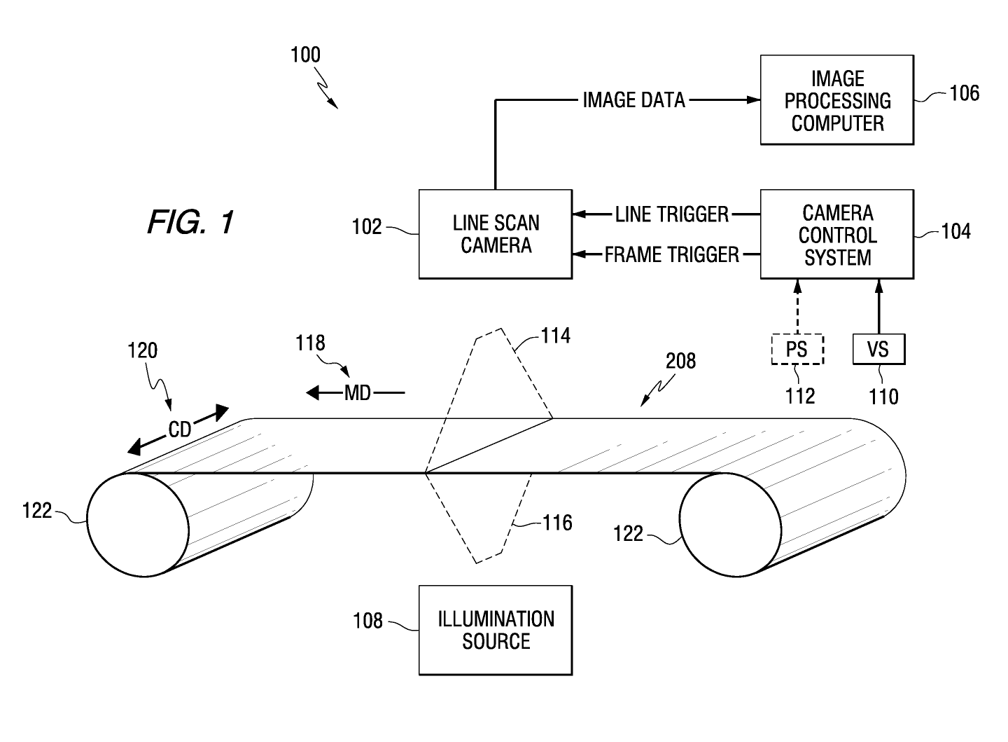

FIG. 1 illustrates one embodiment of a line scan camera system 100 positioned in conjunction with a moving web 208. The moving web 208 may be comprised of a series of products and/or product components. For example, the moving web 208 may be comprised of a series of absorbent articles, or components thereof, joined end to end. The line scan camera system 100 may comprise a line scan camera 102, a camera control system 104 and an optional image processing computer 106. The line scan camera system 100 may be positioned to monitor the moving web 208 and its products and/or components. An illumination source 108 may provide illumination for images captured by the camera 102. The various components 102, 104, 106 may be in electronic communication with one another according to any suitable system or method including, for example, via a direct wired connection and/or via a wired, wireless, or hybrid communications network.

The line scan camera 102 may be any suitable camera (e.g., simple or smart) with an image capture array having significantly more pixels in one dimension than in the other (e.g., the array may be one-dimensional). Example array sizes for line scan cameras may include, for example 1×1024 pixels and 1×2048 pixels. Some line scan cameras may have pixel arrays that are more than one pixel wide. As an example, a line scan camera can have two pixels in the machine direction, and then use a method of calculation such as averaging, binning, or summing to generate a single data point derived from those two pixels. Because of its one dimensional pixel array, the line scan camera 102 may have a roughly linear field of view 114 that may extend across the moving web in a cross-direction (arrow 120). The field of view 114 of the camera 102 may be determined by the size of the image array and by imaging optics. The imaging optics may be selected to focus the field of view 114 onto the moving web. Any suitable optical components may be used including, for example, lenses available from NAVITAR and SCHNEIDER OPTICS.

Image frames may be generated one line at a time. As the web 208 advances in the machine direction 118, the field of view 114 of the camera 102 may translate relative to the web 208. Accordingly, consecutively captured one-dimensional images from the camera may be combined to form an image frame showing a desired portion of the web 208 (e.g., a product and/or a portion thereof). The pixel resolution of the field of view 114 in the cross direction may be determined based on the projection of the imaging array onto the web 118 (e.g., via the imaging optics). The pixel resolution of the field of view 114 in the machine direction may be based on the amount of the moving web 118 that translates through the field of view 114 during an image exposure.

It will be appreciated that various different kinds of line scan cameras 102 having various different capabilities may be used. For example, a simple line scan camera may comprise a line trigger signal input. The line trigger signal may prompt the camera to capture a one dimensional image. The one-dimensional image may then be output to an external processing device such as a frame grabber and/or an image processing computer 106, where it may be combined with other one-dimensional images from the camera to form an image frame. In addition to a line trigger input, some simple line scan cameras may also comprise a frame trigger input. These cameras may comprise functionality for combining multiple one-dimensional images into an image frame.

The frame trigger input may indicate to the camera the end of one image frame and the beginning of another. Image data, in the form of an image frame, may be transmitted from the camera to the image processing computer 106. Smart line scan cameras may also receive line and frame trigger signals and may, in addition, comprise a digital signal processor (DSP) and/or other on-board image processing capabilities. For example, some line scan cameras may be programmed to capture image frames and apply inspection algorithms to identify properties and/or defects in the various products and product components included in the web 208. The image data outputted to the image processing computer 106 from these cameras may comprise the results of inspection algorithms. In some embodiments, image frames may be included as well. Examples of line-scan cameras that may be used include, the Basler Runner, the Dalsa Spyder Series (e.g., the Dalsa Spyder 3 Gig E Vision Camera), the DVT 540LS smart camera, the COGNEX 5604 smart camera, etc. It will be appreciated that different applications may utilize line scan cameras that are sensitive in different frequency bands. For example, different line scan cameras may be sensitive in the visible, ultra-violet and/or infrared range. Further, a line array sensor can also be considered a line scan camera, as described herein. For example, a Tichawa Contact Image Sensor could be used.

The illumination source 108 may be any suitable illumination source having a corresponding illumination field 116 that illuminates a portion of the web 208 including the field of view 114. The contours of the illumination field 116 may not exactly match those of the field of view and, in various embodiments, the illumination field 116 may include an area of the web 208 greater than that of the field of view. Also, although the illumination source 108 is pictured below the web 208, it will be appreciated that, in some embodiments, the illumination source 108 may be otherwise positioned relative to the web 208. For example, the illumination source may be positioned above the web 208 such that the resulting illumination field 116 may be reflected off of the web 208 to the camera 102. According to various embodiments, the illumination source 108 may comprise line lights such as light emitting diode (LED) line lights. Examples of such lights include the ADVANCED ILLUMINATION IL068, various line lights available from METAPHASE (e.g., the 17″ line light), various line lights available from VOLPI such as model number 60023, as well as various line lights available from CCS AMERICA, INC. In some embodiments, the illumination source 108 may include halogen or other source lights coupled to generate the field of view 116 via fiber bundles and/or panels. Other example illumination source types may include halogen or other sources coupled to fiber bundles. For example, halogen sources used may include those available from SCHOTT and fiber bundles and/or panels used may include those available from SCHOTT and/or FIBEROPTICS TECHNOLOGY INC.

Depending on the application, the illumination source may be chosen to emit light in any suitable frequency range including, for example, ultra-violet, visible and/or infrared.

The line trigger and/or frame trigger signals for the camera 102 may be generated by a camera control system 104. The camera control system 104 may be implemented as any suitable type of computer hardware. For example, according to various embodiments, the camera control system 104 may comprise a field programmable gate array (FPGA) and/or an application specific integrated circuit (ASIC). In some embodiments, the functionality of the camera control system 104 may be implemented by a local image processing computer 106 in communication with at least the camera 102. Also, according to various embodiments, the functionality of the camera control system 104 may be implemented by the image processing computer 106 or another server or computer in communication with the camera 102 and at least one other camera. It will be appreciated that the camera control system 104 may be physically located on or the near the web 208 and camera 102 and/or may be located at a central location and in communication with the camera 102 via a wired and/or wireless network.

An image processing computer 106 may be present, for example, to perform inspection and identification tasks on the image data received from the line scan camera 102. Some image processing computers 106 may be local computers that are specific to a single camera 102 or small group of cameras (e.g., cameras installed near one another along the web 208). For example, local image processing computers 106 may be in communication with some camera types via a direct wired link such as, for example, a CAMERALINK connection. Some local image processing computers may be in communication with cameras via other means such as, for example, a data communications network. According to various embodiments, local image processing computers may comprise EVS or CVS systems available from NATIONAL INSTRUMENTS. In various embodiments, some image processing computers 106 may be central image processing computers in communication with multiple cameras via a data communications network. A central image processing computer may process images from the cameras that it is in communication with. In some embodiments, central image processing computers may comprise faster hardware configured to apply more complex, processing-intensive inspection algorithms. Additional processing capacity may also allow central image processing computers to perform simple algorithms on images captured from a large number of cameras.

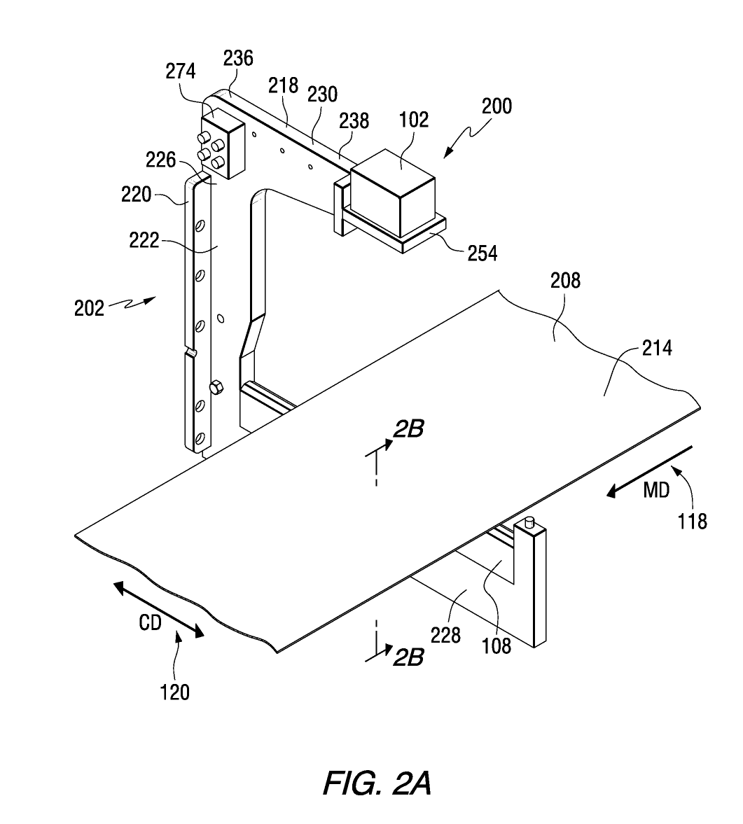

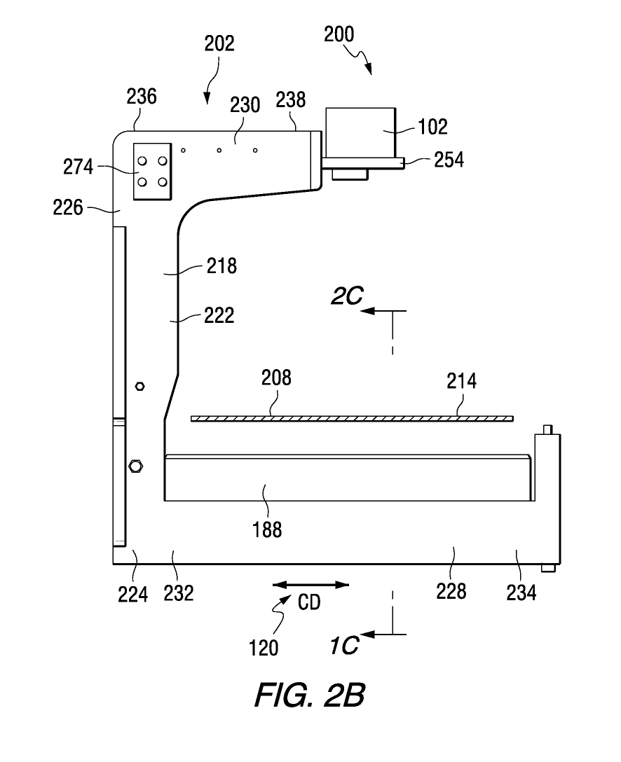

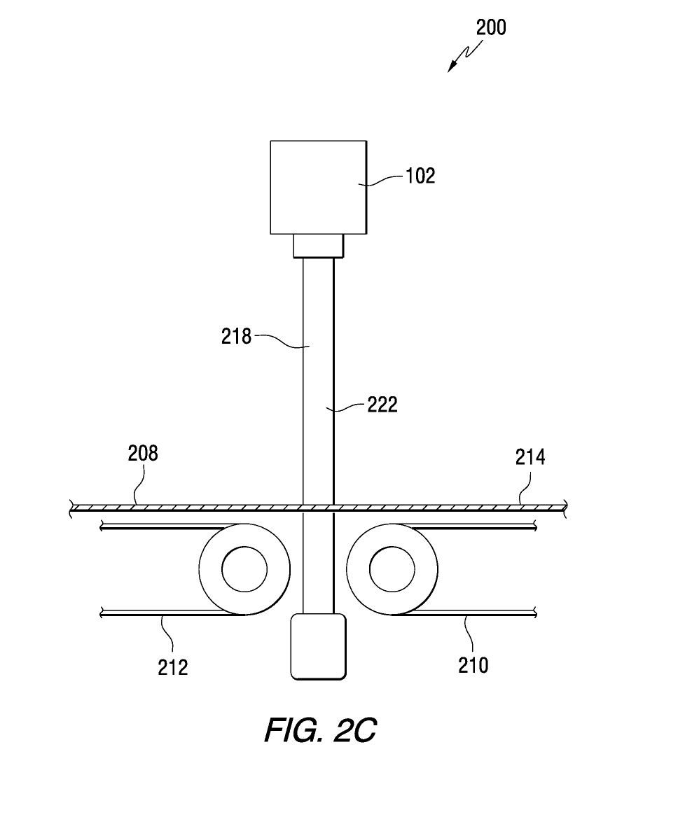

The camera 102 and illumination source 108 may be mounted using any suitable configuration and/or mechanism. FIGS. 2A-2C illustrate one embodiment of a support apparatus 202 for supporting the line scan camera system 100. The support apparatus 202 is shown in FIGS. 2A-2C as being used in a manufacturing process disposed adjacent the moving web 208 advancing in a machine direction 118 such that the camera 102 can monitor and/or view the advancing web 208. With reference to FIG. 2C, the web 208 is shown as advancing along a first conveyer 210 and a second conveyer 212, and the support apparatus 202 is positioned in a gap 215 in the machine direction 118 between end portions of the conveyors 210, 212. As such, the camera 102 is positioned so as to view a top side or surface 214 of the advancing web 208 and the light source 108 is positioned so as to direct light onto a bottom side or surface 216 of the advancing web. The support apparatus 202 can be bolted or otherwise secured to a wall or some other fixture adjacent the advancing web (e.g., via a securement plate 220). As discussed in more detail below, the support apparatus 202 can also be configured to provide air flow along the light source 108 to help maintain cleanliness and/or to help cool the light source. In addition, the support apparatus 202 can be configured to allow a user to move the camera 102 in a limited number of directions with respect to the light source 108 for relative ease of alignment of the camera with the light source.

The main support member 218 includes an upright base member 222 having a first end portion 224 and a second portion 226 connected with a first support member 228 and a second support member 230, respectively. More particularly, the first support member 228 includes a proximal end portion 232 and distal end portion 234, wherein the proximal end portion 232 is connected with the first end portion 224 of the base member 222. In addition, the second support member 230 includes a proximal end portion 236 and distal end portion 238, wherein the proximal end portion 236 is connected with the second end portion 226 of the base member 222. As discussed in more detail below, the first support member 228 is adapted to support the light source 108, and the second support member 230 is adapted to support the camera 102, (e.g., via a support plate 254 connected to the distal end portion 238 of the second support member 230). Various cabling from camera 102 may be received by a junction box 274 and coupled to various other components, for example, as described herein. According to various embodiments, the main support member 218 may be constructed such that the base member 222, first support member 228, and second support member 230 are integrally formed as single piece of material. In other embodiments, the base member, first support member, and second support can be formed as separate pieces that are connected together in various ways to prevent movement relative to each other, such as with for example, fasteners, adhesives, or welding. In addition, the main support member 218 can also be made from different types of materials, such as metal, plastics, and carbon composites. For example, one embodiment of the main support member is constructed as a single integral piece made from aluminum. In various embodiments, the camera 102 and the illumination source 108 can be supported by a support apparatus as described in U.S. patent application Ser. No. 12/367,852, entitled “Apparatus and Method for Supporting and Aligning Imaging Equipment on a Web Converting Manufacturing Line,” filed Feb. 9, 2009.

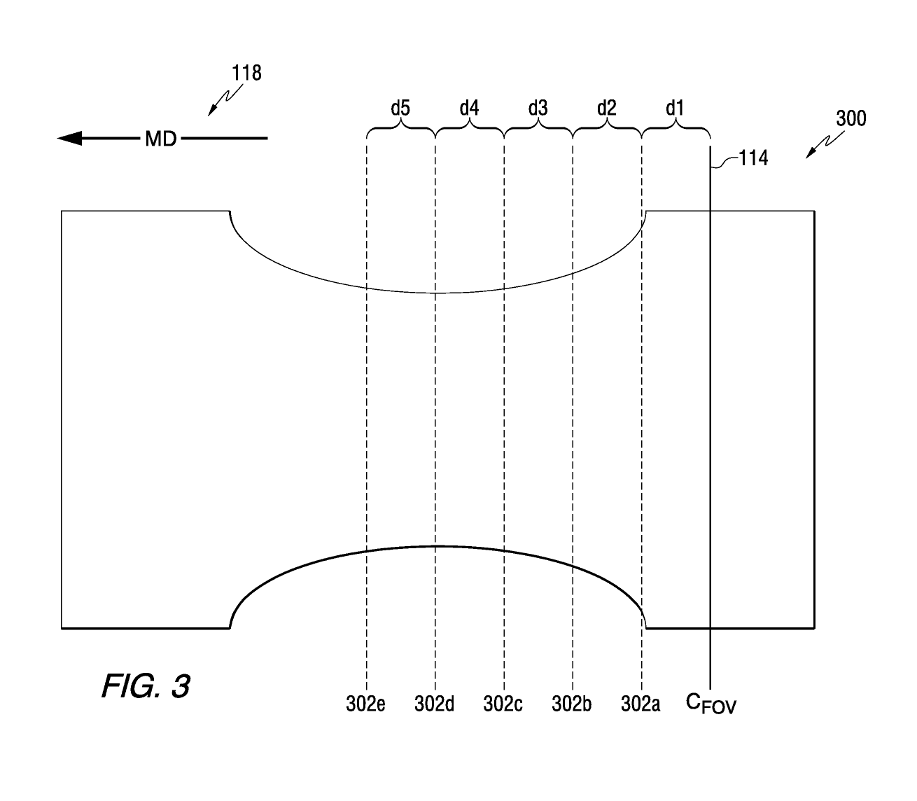

According to various embodiments, the line scan camera system 100 may be configured such that, for an image frame, each pixel in the machine direction 118 corresponds to a constant length of the moving web 208 (e.g., a constant machine direction pixel resolution). As described above, each image frame pixel in the machine direction 118 may be derived from a separate image from the line scan camera 102. Accordingly, the pixel resolution of each machine direction pixel may be based on the linear measure of the web 208 that advances through the field of view 114 during the exposure of each image. FIG. 3 illustrates one embodiment of a product 300 of the moving web 208 illustrating a series of image positions. A current position of the field of view 114 is shown. Previous positions of the field of view relative to the product 300 are shown at 302a-302e. One camera image is taken beginning when the field of view 114 is at each of the positions 302a-302e. For the purposes of this example, it is assumed that the exposure time extends from the time an image is initiated until the time that the next image is initiated. Accordingly, the machine direction pixel length of any one image is equivalent to the portion of the product 300 that moves past the field of view 114 while the image is exposed. For example, the machine direction pixel length of the image captured beginning at 301a is equal to d1. The machine direction pixel length of the image captured beginning at 301b is d2, etc. To achieve a constant machine direction pixel resolution, the distances d1, d2, d3, d4, d5 and so on should be substantially equal. This may be accomplished by manipulating the positions, relative to the product 300, where images are captured by manipulating the line trigger input to the camera 102. In some embodiments, the exposure time for each image may be set to a constant value, such as 10 μs (micro-seconds). In this way, changes in image intensity due to differences in image exposure time may be avoided.

According to various embodiments, the line trigger signal of the camera 102 may be generated (e.g., by the camera control system 104) to achieve a constant machine direction pixel resolution. For example, the camera control system 104 may generate the line trigger signal based on the velocity of the web 208. The web 208 may be propelled down the line in the machine direction by line equipment such as rollers 122 (FIG. 1) and/or belts 210, 212 (FIG. 2C). Due to various factors, the velocity of the web 208 may not match the velocity of the line equipment. For example, the moving web 208 may be made of materials that are elastic and may stretch or contract on-line. Also, for example, the web 208 may slip relative to the rollers 122 or belts 210, 212, causing the web to have a velocity different than that of the line equipment. In some instances, the web velocity may be intentionally varied, for example, using a zero speed splicer, an accumulator and/or a festooner. To allow for variable web velocity, the camera control system 104 may receive velocity data from a velocity sensor 110. The velocity sensor 110 may directly sense the velocity of the web 208 (e.g., in the machine direction 118) at or near the field of view 114 of the camera 102.

The velocity sensor 110 may be any suitable type of sensor capable of finding a velocity of the moving web 208. For example, the velocity sensor 110 may comprise a laser Doppler sensor such as those available from ACUITY LASER MEASUREMENT. A laser Doppler sensor may reflect laser energy off of a portion of the moving web 208 and measure a frequency shift of the return signal. Due to the Doppler effect, the frequency shift may indicate web 208 velocity. In various embodiments, the velocity sensor may comprise an image correlation sensor, such as the INTACTON OPTIPACT available from FRABA. An image correlation sensor may find the velocity of the web based on the translation in time between patterns found in the web 208. In some embodiments, the velocity sensor may comprise a frequency analysis sensor, such as the INTACTON COVIDIS, also available from FRABA. A frequency analysis sensor may monitor the spatial frequency of changes in various patterns, textures or even random variances in the web 208 in order to determine its velocity.

Based on the velocity of the web 208, the camera control system 104 may generate a line trigger signal. For example, based on the velocity of the web 208, the camera control system 104 may be programmed to find a time during which a predetermined length of the web 208 (e.g., ⅓ mm) will pass through the field of view 114 of the camera 102. The calculated time may become a period of the line trigger signal. As the velocity of the web 208 changes, the period of the line trigger frequency may be updated to maintain a constant machine direction pixel resolution. In some embodiments, the machine direction pixel resolution may be set equal to the cross-direction pixel resolution of the camera (e.g., the length of web 208 passing through the field of view 114 between line triggers may be set equal to the width of web corresponding to one pixel in the cross direction 120). In this way, the camera 102 may generate image frames having square pixels. It will be appreciated that the line trigger signal may be transmitted to the camera in various forms. For example, the line trigger signal may be a square wave or other suitable waveform comprising a period substantially equal to the period found by the camera control system 104 based on the web 208 velocity. According to various embodiments, the line trigger signal may be communicated to the camera 102 in the form of a numerical representation of the frequency and/or the period of the desired image captures. Line trigger signals in either form may be transmitted to the camera 102 either according to a single wire connection or a data link such as an Ethernet/IP and/or TCP/IP, etc.

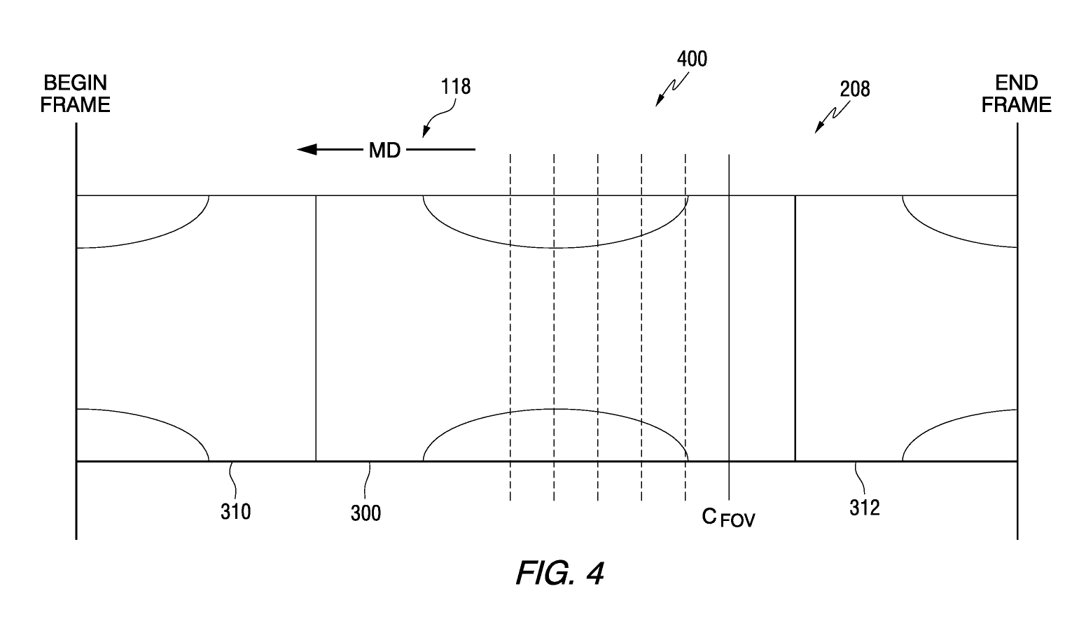

In addition to generating the line trigger signal, the camera control system 104, in various embodiments, may also generate the frame trigger signal for the camera. The frame trigger signal may be configured to result in image frames showing a product or component on the moving web 208. For example, it may be desirable to capture an image frame showing a complete product and/or component thereof and/or multiple products. To ensure that at least one complete product and/or component is in each image frame, image frames may be selected to include the complete product or component as well as portions of the products or components immediately adjacent to the first product or component. FIG. 4 illustrates one embodiment of an image frame 400 showing a portion of the web 208 comprising the product 300 and portions of adjacent products 310 and 312.

The camera control system 104 may generate the frame trigger signal according to any suitable method. For example, the mechanism causing the web 208 to move (e.g., the roller 122, the belts 210, 212 and/or various other components) may be configured to generate a master machine pulse once per product, when the leading edge of the product is at a known position. The camera control system 104 may receive the machine pulse and may also be programmed with an offset between the position of the field of view of the camera 102 and the known position as well as a product pitch length, or length between the leading edges of consecutive products. Based on the offset, the pitch length and the web velocity (e.g., received from the velocity sensor 110), the camera control system 104 may derive a time when the leading edge of a product is at the field of view 114 of the camera. At this time, a frame trigger signal may be generated and transmitted to the camera.

To generate an image frame similar to the image frame 400 that includes an entire product 300 and portions of adjacent products 310, 312, the camera control system 104 may offset the frame trigger signals. For example, the image frame 400 comprises all of the product 300 and approximately half of each of the adjacent products 310, 312. To achieve this configuration, the period of the frame trigger may be doubled to include two complete products. Also, the frame trigger may be offset by 50% relative to the arrival of a product leading edge at the field of view 114. The offset may be calculated as a portion of the product pitch length. Recalling that the line trigger signal may correspond to a predetermined length of the web 208 passing the field of view, the offset may be implemented by delaying the frame trigger signal until a predetermined number of cycles of the line trigger signal have occurred.

According to various embodiments, the camera control system 104 may also be in communication with a product sensor 112. The product sensor 112 may sense a known portion of a product as it passes a known location relative to the field of view. This may give the camera control system 104 an indication of when a leading edge or other portion of a product passes the field of view 114. The product sensor 112 may be any suitable kind of sensor including, for example, a through-beam and/or reflective photoelectric sensor. According to various embodiments, a product sensor 112 may provide a more accurate reading than the machine pulse because the product sensor 112 may allow for effects such as slippage and stretching of the web 208 relative to the rollers 122 and/or belts 210, 212.

Although the image frame 400 illustrates a complete product 300, it will be appreciated that, in various embodiments, the camera control system 104 may generate the frame trigger signal to result in image frames showing less than all of a product. For example, it may be desirable to generate image frames focusing on a particular component of a product. The camera control system 104 may be programmed with an offset of the desired component relative to the leading edge or other detectable portion of the product. Based on the offset, the camera control system 104 may generate frame trigger signals to generate an image frame including the desired component as well as a portion of the product adjacent to the component. Also, it will be appreciated that, in some embodiments, the image trigger of a camera 102 may be manipulated to result in image frames showing multiple examples of whole products and/or components. These image frames may allow an image processing computer 106 to inspect images of multiple products and/or components simultaneously.

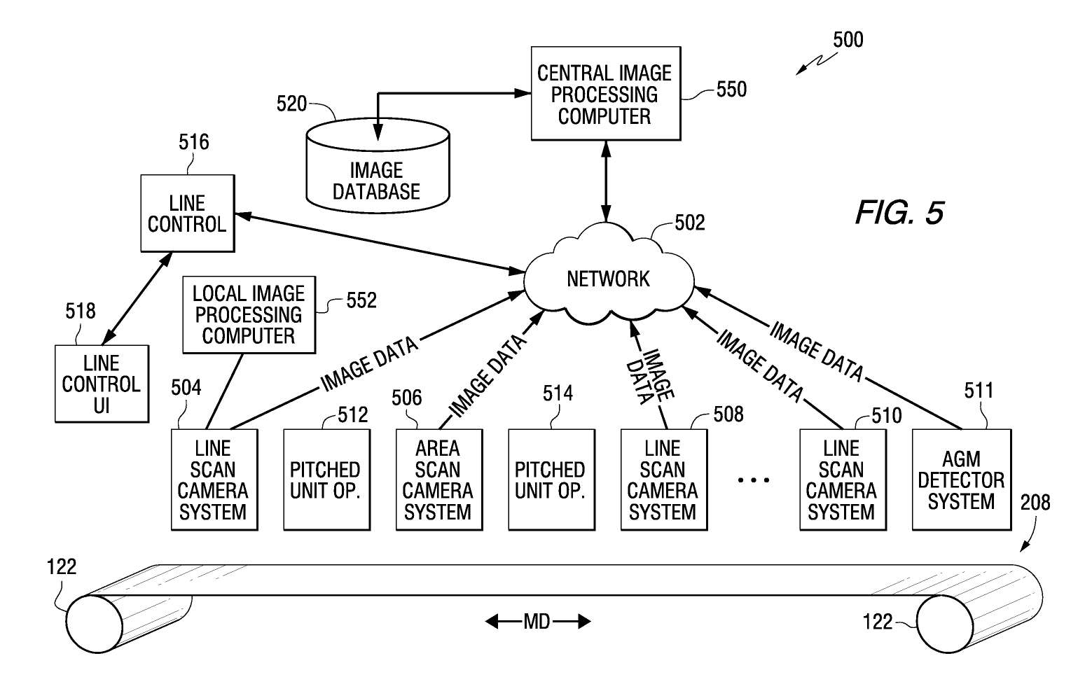

FIG. 5 illustrates one embodiment of an inspection system 500 comprising a plurality of camera systems 504, 506, 508, 510. The camera systems 504, 506, 508 may be centrally networked to one or more central image processing computers 550 and image database 520, for example, via a network 502. The camera systems 504, 506, 508, 510 may comprise line scan camera systems 504, 508, 510. In some embodiments, one or more area scan camera systems, such as system 506 may also be included. Some line scan camera systems, such as system 504, may be in communication with a local image processing computer 552, for example, via a direct wired link. The network 502 may be any suitable type of wired, wireless or hybrid network including, for example, a local area network (LAN) a wide area network (WAN) such as the Internet, etc. According to various embodiments, the network 502 may comprise a router and/or Ethernet switch. The system 500 may also comprise a plurality of pitched unit operations 512, 514. The pitched unit operations 512, 514 as well as the rollers 122 and/or conveyers 210, 212 (not shown in FIG. 5) controlling the motion of the web 208 may be controlled by a line control system 516. For example, the line control system 516 may comprise logic for coordinating the various rollers 122 and pitched unit operations 512, 514. A line control user interface 518 may allow a line operator to manipulate and view the status of the line and pitched unit operations 512, 514.

Some or all of the plurality of line scan camera systems 504, 508, 510 may comprise a camera control system similar to the camera control system 104 described above. For example, the camera control system corresponding to each of the camera systems 504, 508, 510 may generate line trigger and/or frame trigger signals for their respective cameras. Also, although four camera systems 504, 506, 508, 510 are shown, it will be appreciated that more or fewer camera systems may be included in the system 500, for example, based in the requirements of the line or lines.

According to various embodiments, the various line scan camera systems 504, 508, 510 may comprise disparate types of line scan cameras including smart cameras and simple cameras. Camera system 504 may be a simple line scan camera that may capture one-dimensional images and provide them to an external component such as a camera control system 104, the local image processing computer 552, a frame grabber board and/or the central image processing computer 106, where the images may be formed into frames and/or inspect them. Camera system 508 may comprise a simple line scan camera that receives line trigger and frame trigger inputs and provides as output an image frame. The image frame may be transmitted to the camera control system 104 or other local image processing computer and/or to the image processing computer 106, where various inspection algorithms may be applied. Also, for example, the camera system 510 may comprise a smart line scan camera comprising a DSP or other processing functionality for applying image processing and/or other product inspection algorithms. In addition to including different types of line scan cameras, the plurality of camera systems 504, 506, 508, 510 may comprise cameras and other hardware from different manufacturers.

According to various embodiments, the camera systems 504, 506, 508, 510 may be configured to communicate with the image processing computer 106 across the network 501 according to a common or similar protocols. For example, the various systems 504, 506, 508, 510 may be GIGE VISION compliant. Also, for example, the systems 504, 506, 508, 510 may be compatible with file transfer protocol (FTP), the Ethernet/IP protocol, IEEE1394 (FIREWIRE) and/or a TCP/IP protocol.

The system 500 may be configured to pinpoint the location on the line where a defect or property was introduced to the web 208. This may make it possible to identify a pitched unit operation 512, 514 or other line component that caused the defect, allowing corrective action to be taken to prevent future defects. For example, systems 508 and 506 may be positioned on either side of the pitched unit operation 514, as shown. In this configuration, if no defect is detected by the system 508, but a defect is detected by the system 506, it may be inferred that the defect resulted from the pitched unit operation 514.

According to various embodiments, the system 500 may be utilized to enrich line data by combining images received from the systems 504, 506, 508, 510 with other sensed information. For example, the system 500 may comprise an absorbent gel material (AGM) detector system 511, such as those disclosed in US patent application entitled “Method and System for Evaluating the Distribution of An Absorbent Material in an Absorbent Article,” filed Dec. 16, 2009 under attorney docket number [TO BE ADDED]. The AGM detector system 511 may comprise an infrared source positioned on one side of the web 208 and an infrared sensitive sensor positioned on an opposite side of the web 208. The source may be selected to emit infrared energy at a wavelength that is absorbed by the AGM to be detected. Accordingly, the source may emit infrared radiation which, after passing through the web 208, may be received by the sensor. The amount of energy absorbed by the web 208 may indicate an amount of AGM present in the web 208. According to various embodiments, the amount of absorption may be measured by also including a reference source at a frequency that is not absorbed by the AGM. A difference between the sensed intensity between the received energy from the first source and the received energy from the reference source may provide an indication of absorption. In some embodiments, the reference source may be omitted. In these embodiments the first source may be calibrated utilizing target objects including AGM and/or using targets having optical properties similar to those of AGM (e.g., soda-lime glass).

In some embodiments, the AGM detector system 511 may comprise an array of sources and sensors, allowing the system 511 to detect a degree of AGM presence across the cross direction 120 of the web 208. For example, the AGM detector system 511 may comprise a line scan camera with an array that is sensitive to infrared radiation. Information from the AGM detector system 511 may be provided to the image processing computer 106. According to various embodiments, the image processing computer 106 may be configured to superimpose an indication of AGM intensity in a given product over a visual band image frame showing that product. For example, the image processing computer 106 may be pre-programmed with an offset between the location of the AGM detector system 511 and at least one of the line scan camera systems 504, 506, 508, 510.

According to various embodiments, the system 500 may also be utilized to implement a tiered image processing scheme. For example, each image frame captured at one of the systems 504, 506, 508, 510 may be subjected to a predetermined first tier inspection algorithm or algorithms. First tier inspection algorithms may generally be computationally inexpensive to apply and may analyze the pictured products or components for simple properties. For example, first tier algorithms may find physical dimensions of a product, look for the presence of a hole, pattern or other product component, etc. It will be appreciated that, depending on the line scan camera type, the first tier algorithms may be applied either at the systems 504, 506, 508, 510, at a local vision processing computer 552 common to one or more of the systems 504, 506, 508, 510 or at the central image processing computer 550. For example, if a camera system 508 has DSP or other processing capacity, its output, for each product, may indicate only that the product has passed or failed each first tier algorithm. If a camera system 504, 506, lacks on-board processing capacity, the first tier algorithms may be applied at the local image processing computer 552 or a central image processing computer, such as the computer 550.

Provided that a product passes the first tier algorithms, no further action may be taken. If a product fails a first tier algorithm, however, or if a first tier algorithm cannot generate a result to a sufficient level of confidence, then one or more second tier algorithms may be applied, for example, at central image processing computers, such as the computer 550. Second tier algorithms may be image processing algorithms that are more computationally expensive than first-tier elements. For example, camera systems 504, 506, 508, 510 and/or local image processing computers, such as the computer 552, may lack the processing capacity to practically perform second-tier algorithms on every image frame in real-time. Examples of second-tier algorithms may include, for example, wavelet analysis for locating and/or measuring textures, optical density algorithms for measuring a product density, Euclidian distance mapping, etc. The second tier algorithms may be used to confirm or deny the presence and correctness of the measured product or component thereof.

In one example, a first-tier algorithm may analyze an image to verify the location of a hole in a product. The hole may have been introduced to the product web by a pitched unit operation 512, 514. If the first tier algorithm indicates that the hole is present as expected, then no further action may be taken. If, on the other hand, the first tier algorithm indicates that the hole is not present and/or indicates that it cannot prove the presence of the hole to a predetermined level of confidence, then the image frame showing the product may be sent to the image processing computer 106 for application of a second tier algorithm. For example, the image processing computer 106 may apply a wavelet analysis to verify the presence of the expected hole. If the second tier analysis indicates that the hole is not present, this may indicate a malfunction in the pitched unit operation 512, 514.

It is understood that the examples and embodiments described herein are for illustrative purposes only and that various modifications or changes in light thereof will be suggested to one of skill in the art without departing from the scope of the present invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description are, in relevant part, incorporated herein by reference; the citation of any document is not to be construed as an admission that it is prior art with respect to the present disclosure. To the extent that any meaning or definition of a term in this document conflicts with any meaning or definition of the same term in a document incorporated by reference, the meaning or definition assigned to the term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. An apparatus for inspecting an on-line product web moving relative to the apparatus in a machine direction, the apparatus comprising:
a line-scan camera defining a field of view and positioned such that the field of view includes a portion of the product web;
an illumination source positioned to illuminate the product web;
a web velocity sensor positioned to sense a velocity of the product web in the machine direction;
a camera control system in electronic communication with the camera comprising at least one computer hardware component configured to:
receive from the web velocity sensor web velocity data indicating a velocity of the product web;
convert the web velocity data to a line trigger signal, wherein the line trigger signal indicates a temporal frequency of camera image captures necessary to achieve a constant machine direction pixel resolution;
electronically communicate the line trigger signal to the camera;
receive product position data indicating a position of at least one product on the web relative to the field of view of the camera;
generate a frame trigger signal considering the product position data, wherein the frame trigger signal indicates a break between image frames captured by the camera, and wherein each image corresponds to at least one object on the web selected from the group consisting of a product and a component of a product; and
electronically communicate the frame trigger signal to the camera.

2. The apparatus of claim 1, wherein the constant machine direction pixel resolution is equal to a pixel resolution of the line-scan camera in a cross direction.

3. The apparatus of claim 1, wherein the product position data comprises a machine pulse received from line equipment propelling the web.

4. The apparatus of claim 1, further comprising a product position sensor in communication with the camera control system, wherein the product position sensor provides the product position data to the camera control system.

5. The apparatus of claim 1, wherein the camera control system is further configured to offset the frame trigger signal by a predetermined distance from the position of the at least one product by offsetting the frame trigger signal by an amount of time equal to a multiple of the line trigger signal corresponding to the predetermined distance.

6. The apparatus of claim 1, wherein the line trigger signal comprises a plurality of pulses, wherein each pulse corresponds to a single image to be captured by the camera.

7. The apparatus of claim 1, wherein the line trigger signal comprises a numerical representation of the camera frequency.

8. The apparatus of claim 1, wherein the web velocity sensor is selected from the group consisting of a laser Doppler sensor, an image correlation sensor and a frequency analysis sensor.

9. The apparatus of claim 1, wherein the computer hardware component comprises at least one device selected from the group consisting of: a field programmable gate array (FPGA), an application specific integrated circuit (ASIC), and a microprocessor.

10. An apparatus for inspecting an on-line product web moving relative to the apparatus in a machine direction, the apparatus comprising:
a first line-scan camera defining a first field of view and positioned such that the first field of view includes a portion of the product web;
first camera control system in electronic communication with the first camera, wherein the first camera control system comprises at least one computer hardware component configured to generate a first line trigger signal, wherein the first line trigger signal indicates a temporal frequency of camera image captures necessary to achieve a constant machine direction pixel resolution;
a second line-scan camera defining a second field of view and positioned such that the second field of view includes a portion of the product web, wherein the second line-scan camera is configured to apply at least one inspection algorithm to an image frame generated by the second line-scan camera;
a second camera control system in electronic communication with the second camera, wherein the second camera control system comprises at least one computer hardware component configured to:
generate a second line trigger signal, wherein the second line trigger signal indicates a temporal frequency of camera image captures necessary to achieve a constant machine direction pixel resolution;
generate a second camera frame trigger signal considering product pitch data and product phase data, wherein the second camera frame trigger signal indicates a break between image frames captured by the second camera;
an image processing computer in communication with the first camera and the second camera via a network, wherein the image processing computer comprises at least one processor and operatively associated memory and wherein the memory comprises instructions that, when executed by the at least one processor, cause the image processing computer to apply at least a first inspection algorithm to an image frame received from at least one of the first and second cameras, and wherein the first camera and the second camera are configured to communicate with the image processing computer on the network according to a common communication protocol.

11. The apparatus of claim 10, wherein the line comprises a plurality of pitched unit operations spaced in the machine direction, wherein the first camera is positioned in the machine direction upstream of a first pitched unit operation selected from the plurality of pitched unit operation, wherein the second camera is positioned in the machine direction downstream of the first pitched unit operation, wherein the memory of the image processing computer further comprises instructions that, when executed by the at least one processor, cause the image processing computer to:
apply an inspection algorithm to a first camera image received from the first camera;
apply the inspection algorithm to a second camera image received from the second camera; and
when a product web defect is identified in the second camera image and not in the first camera image, store data associating the product web defect with the pitched unit operation.

12. The apparatus of claim 10, further comprising a frame grabber in communication with the first camera and configured to combine a plurality of line images received from the first camera into a first image frame, wherein the image frame corresponds to at least one product web object selected from the group consisting of a product and a product component.

13. The apparatus of claim 10, wherein generating the first line trigger signal comprises receiving from the web velocity sensor web velocity data indicating a velocity of the product web; and converting the web velocity data to a line trigger signal.

14. The apparatus of claim 10, wherein the at least one hardware component of the first camera control system is further configured to generate a first camera frame trigger considering the product pitch data and the product phase data, and wherein the first camera frame trigger signal indicates a break between image frames captured by the first camera;

15. The apparatus of claim 10, further comprising an area scan camera in communication with the image processing computer.

16. The apparatus of claim 10, wherein the common communication protocol is selected from the group consisting of FTP, TCP/IP, IEEE1394 (FIREWIRE), Ethernet/IP and GIGE VISION.

17. An apparatus for inspecting an on-line product web moving relative to the apparatus in a machine direction, the apparatus comprising:
a line-scan camera defining a field of view and positioned such that the field of view includes a portion of the product web;
a camera control system in electronic communication with the camera, wherein the camera control system comprises at least one computer hardware component configured to:
generate a line trigger signal, wherein the line trigger signal indicates a temporal frequency of camera image captures necessary to achieve a constant machine direction pixel resolution; and
generate a camera frame trigger signal considering product pitch data and product phase data, wherein the frame trigger signal indicates a break between image frames captured by the camera, and wherein each image corresponds to one product on the product web;
an image processing computer in electronic communication with the first camera, wherein the image processing computer comprises at least one processor and operatively associated memory;
wherein at least one of the line scan camera and the image processing computer is programmed to apply a first inspection algorithm to the first image;
wherein, the image processing computer is programmed to, conditioned upon the results of the first inspection algorithm indicating an abnormal condition, apply a second inspection algorithm to the first image.

18. The apparatus of claim 17, wherein the first inspection algorithm is applied at the line scan camera.

19. The apparatus of claim 17, wherein the first inspection algorithm is configured to detect the presence of a product component on the moving web, and wherein the abnormal condition indicated by the results of the first inspection algorithm is an indication that the presence of the product component cannot be determined to a predetermined level of confidence.

20. The apparatus of claim 17, wherein the second inspection algorithm is selected from the group consisting of a wavelet analysis algorithm and a Euclidian distance mapping algorithm.
